(19) United States
(12) Patent Application Publication
(10) Pub. No.: US 2025/0361114 A1
(43) Pub. Date: Nov. 27, 2025

(54) DEVICE FOR TRANSPORTING SHEETS IN A FOLDING MACHINE, AND FOLDING MACHINE

(71) Applicant: Heidelberger Druckmaschinen AG, Heidelberg (DE)

(72) Inventors: Mario Pfitzenmeier, Bretten (DE); Udo Ganter, Freiberg am Neckar (DE)

(21) Appl. No.: 19/211,715

(22) Filed: May 19, 2025

(30) Foreign Application Priority Data
May 22, 2024 (DE) 10 2024 114 235.9

(51) Int. Cl. B65H 45/12; B31B 50/04; B65H 5/06; B65H 5/36

(52) U.S. Cl. CPC B65H 45/12; B31B 50/04; B65H 5/06; B65H 5/36

(57) ABSTRACT

A device for transporting sheets in a folding machine has a transport table with a transport direction for the sheets and at least one downholder for the sheets. The downholder is positionable onto the format of the sheets in the transport direction and the downholder has a multi-part finger. The multi-part finger has at least a first part and a second part, with the second part being movable relative to the first part, in order to adjust a length of the finger to the format of the sheets. The device allows for correctly adjusting formats at folding machines and/or respective transport tables in an advantageous manner. There is also described a folding machine with shingled sheet transport in industrial settings, in which the transport device is suitable used.

### CROSS-REFERENCE TO RELATED APPLICATION

This application claims the priority, under 35 U.S.C. § 119, of German Patent Application DE 10 2024 114 235.9, filed May 22, 2024; the prior application is herewith incorporated by reference in its entirety.

### FIELD AND BACKGROUND OF THE INVENTION

The invention relates to a device for transporting sheets in a folding machine. The device includes a transport table with a transport direction for the sheets and at least one downholder for the sheets that is positionable onto the format of the sheets in the transport direction. The invention also pertains to folding machine comprising the device.

The invention lies in the technical field of the graphics industry and particularly in the field of folding flexible sheet-shaped printing materials and in the field of industrial, i.e., high quality and high productivity, production of folded products such as brochures, preferably from paper, cardboard, plastic, or composite material, and particularly from printed paper. The invention basically relates to smoothly transporting the sheets in and/or through folding machines.

Industrial folding machines of the prior art are known to comprise multiple folding assemblies (folding stations) for producing folded products from sheet-shaped printing materials from paper, for example, and conveying assemblies for moving the folded products. The folding assemblies may be buckle fold units and/or knife fold units for creating preferably multiple folds, for example. The conveying assemblies may be roller tables with tilted conveying rollers, for example. Such folding machines typically also comprise a feeder, e.g. a staple feeder, for the sheets to be folded, and a delivery for the folded products. The sheets to be folded may preferably be conveyed as a stream and more preferably as a shingled stream to the first fold unit. In high end machines, conveying between folding assemblies as a so-called shingle is also possible. Such folding machines further comprise a machine controller in the form of a digital computer with control software.

So-called rulers on the roller tables are common features to align the transported sheets therewith and to provide them with a defined direction of (further) movement. Buckle fold machines with more than one folding station typically have a roller table downstream of the (first) fold unit to redirect the exiting sheet by 90° and transport it to the next (second) fold unit. For accelerating the sheet fast and with little slip, balls or conical rollers typically generate a normal force from above onto the sheet. For the sheet to securely pass below the balls or rollers and up to the stop on the ruler, downholder elements are employed. Securely installed introduction plates on the ruler and manually adjustable downholders have become established as such elements, which are positioned above the sheet edges or the sheet surface by the user depending on the format. Using additional downholders depends on factors such as grammage, type of fold, or folding rate, among others.

In faster, shingled folding in high end machines, such as, e.g., the Heidelberger Druckmaschinen AG steel folder TH82 P folding machine, a rail that is referred to as ruler with balls that are received in holes of the rail (ball rail or so-called “ball ruler”) is used. Compared to the sheet transport of single sheet machines without shingling, the special feature is that the ruler is not fully equipped with balls in the initial region. Deliberately omitting balls facilitates a subsequent sheet to slide over an underlying sheet and therefore building the shingle and evenly abutting the ruler. In the region of the front sheet corner abutting the ruler, some balls are lifted by a slidable lifter. With larger format widths, the slider is moved further in the transport direction, thereby lifting more balls; with smaller format widths, the slider is moved less far in the transport direction, thereby less balls are lifted. In addition, the lifter closes the recesses for the balls in the ball ruler at the bottom of the ball ruler, thereby preventing the preceding sheet edge from engaging and malfunctions caused by the engagement. Adjusting the lifter is performed manually by the user. The specific feature of shingled folding is that the sheets exiting from the preceding station (folding station) are directed directly onto the roller table and then slide parallel to the latter towards the ruler. During transport, the sheets rest flat and using downholders is particularly important here to prevent the sheets from rising. In the TH82 P, downholders are used, which are clamped to an introduction plate of the ruler. There is a long embodiment of the downholder used for symmetrical types of fold and long formats, for example; and there is a short embodiment, e.g., for unsymmetrical types of fold and short sheet formats. Switching from long formats to short formats at the roller table requires the long downholders to be manually exchanged for short ones. In practice, disassembled downholders have been proven to not have a designated storage location and therefore are often lost. Their absence later for other formats may cause problems in the sheet transport. Furthermore, the downholders may be installed or adjusted incorrectly by the user, thus disrupting the sheet transport. Additionally, the lifter has to be adjusted to the current format by the user to prevent errors in shingling caused by excessive friction between the sheets or jammed paper caused by engaged paper corners. In practice, the required positioning precisely (to the format) of the lifter has proven to be difficult for inexperienced users, and errors may result in cost-incurring machine downtimes.

German Patent DE 10 2013 107 598 B3 discloses an apparatus for creasing paper sheets using a device for transporting the sheets by means of transport rollers having a transport direction and a movable and fixable downholding means. The downholding means comprises balls, and a means for alignment is arranged on the downholding means.

Producers producing high quality printed products in an increasingly industrial manner and being subjected to continuous and fierce competition continuously make demands to manufacturers of (high end) folding machines to improve such machines, firstly in order to lower production cost for printed products and avoid, or at least reduce, potential production downtime, and secondly in order to improve even further the already high quality of the printed products. Another demand results from an increasing lack of well-trained personnel. Thus, the machines are often operated by less trained personnel, while operating errors still have to be avoided. This issue is addressed by the instant invention.

### SUMMARY OF THE INVENTION

It is accordingly an object of the invention to provide a device for transporting sheets in a folder which overcomes the above-mentioned disadvantages of the heretofore-known devices and methods of this general type and which provides for an improvement over the prior art which allows for correctly performing format adjustments to folding machines and/or respective transport tables.

With the above and other objects in view there is provided, in accordance with the invention, a device for transporting sheets in a folding machine, the device comprising:
a transport table having a transport direction for the sheets to be transported;
at least one downholder for the sheets, the downholder being positionable onto a format of the sheets in the transport direction; and
the downholder having a multi-part finger with at least a first part and a second part, and wherein the second part is movable relative to the first part for adjusting a length of the finger to the format of the sheets.

Advantageous, and therefore preferred, further developments of the invention result from the dependent claims as well as from the description and the drawings.

In other words, the device according to the invention for transporting sheets in a folding machine comprising a transport table with a transport direction for the sheets and at least one downholder for the sheets that is positionable onto the format of the sheets in the transport direction. The downholder has a multi-part finger, with at least a first part and a second part, wherein the second part is movable relative to the first part such that the length (e.g., labeled with L1) of the finger is adjustable to the format of the sheets.

A folding machine utilizing the device according to the invention, comprising a first folding station and a second folding station arranged downstream in the production flow, includes the device according to the invention arranged in the production flow between the first folding station and the second folding station. It may be provided for the first folding station to be a buckle fold unit, for the second folding station to be a buckle fold unit, for the transport direction of the transport table to be transverse to an output direction of the first folding station, and/or the transport direction of the transport table to be parallel to a feeding direction of the second folding station.

It is advantageous that the invention allows for correctly adjusting formats at folding machines and/or respective transport tables. The invention is especially suitable for folding machines with shingled sheet transport in industrial settings, for example.

It is a further advantage that the invention allows for the user to quickly and easily adjust downholders for the sheet transport in folding machines to different format lengths and format widths without the need of a complex exchange or removal. On the one hand, this may advantageously prevent removed downholders from being reinstalled or incorrect downholders from being installed. On the other hand, this makes it easier for the user to select correct format settings, particularly in the case of a lack of proper experience with such settings. Other specific advantages: Increased ease of use by fast, simple and tool-free displacement of the downholders to format width; fast, simple and tool-free length adjustment of the downholders to format length, particularly without requiring an exchange of components; elimination of the additional adjustment operation for the (ball) lifter; increased process reliability in folding by a downholder positioned correctly and a lifter positioned correctly.

The downholder is a (multi-part) element which is for holding down the sheets onto the transport table at the location of the downholder, i.e., preventing them from moving upward from the transport table while being transported. The length of the finger preferably is an effective length, i.e., the length of the distance effected by the function of holding down. Preferably, the length is measured in a direction transverse to the transport direction. The finger being of multiple parts preferably means the number of parts of the finger effecting the function of holding down, e.g., 2 or 3, at least one of which is movable, particularly pivotable, to be able to adjust the length. The format of the sheets may be indicated as a length (parallel to the transport direction) and a width (transverse to the transport direction); this format may change due to the folding operations following each folding station, e.g., being halved; at the same time, the length and width values may be switched due to change of directions during transport, e.g., by 90°.

In accordance with an added feature of the invention, the second part is arranged on the first part. A further development may be characterized by the second part being pivotable relative to the first part. A further development may be characterized by a disc spring being present that generates inhibition between the second part and the first part. A further development may be characterized by at least one stop being present for the second part. A further development may be characterized by the stop being arranged on the first part.

In accordance with an added feature of the invention, the second part is slidable relative to the first part. In a further development the second part being telescopically slidable relative to the first part.

In accordance with an additional feature of the invention, the multi-part finger comprises a third part which is movable relative to the second part such that the length of the finger is adjustable to the format of the sheets. A further development may be characterized by the third part being arranged on the second part. A further development may be characterized by the third part being pivotable relative to the second part. A further development may be characterized by the third part being pivotable in conjunction with the second part. A further development may be characterized by another disc spring being present that generates inhibition between the third part and the second part. A further development may be characterized by at least one other stop being present for the third part. A further development may be characterized by the other stop being arranged on the second part.

In accordance with yet an added feature of the invention, the third part is slidable relative to the second part. In a further development, the third part is telescopically slidable relative to the second part.

In accordance with yet an additional feature of the invention, the device comprises a linear guide, the longitudinal direction of which is parallel to the transport direction, and a slider being present which is slidably arranged on the linear guide and which the downholder is arranged on. A further development provides for the linear guide to be positionable transverse to the transport direction of the sheets onto the format of the sheets. Again a further development has the linear guide formed as a rail. Further, the rail may be formed as a round rod. A further development may be characterized by the slider comprising a clamping element, e.g., a clamping screw, by which the slider is fixable to the rail. In accordance with yet a further development the downholder may be pivotably arranged on the linear guide. Finally, there may be a stop provided for pivoting.

In accordance with again a further feature of the invention, the downholder has a guide surface for the sheets, and in a further development the guide surface is tilted upwards relative to the horizontal. Yet a further development has the guide surface forming the top of a hopper for the sheets. A further development may be characterized by the guide surface being formed by a bottom of the first part. A further development may be characterized by the guide surface being formed by a bottom of the first part and a bottom of the second part. A further development may be characterized by the guide surface being formed by a bottom of the first part, a bottom of the second part, and a bottom of the third part. A further development may be characterized by the guide surface being a flat and smooth surface. A further development may be characterized by the guide surface comprising an inlet region. A further development may be characterized by the inlet region being tilted even more upwards than the guide surface. A further development may be characterized by the inlet region being formed on the first part. A further development may be characterized by the inlet region being formed by the second part. A further development may be characterized by the inlet region being formed on the third part.

In accordance with a further feature of the invention, the transport table is a roller table.

Further, the device may have the afore-mentioned downholder and at least one other downholder. Each of the two, or more, downholders has a multi-part finger, the respective lengths (e.g., labeled with L1a and L1b) of which are adjustable to the format of the sheets. A further development may be characterized by a downholder being positioned in the region of the leading edge of the sheet and the other downholder being positioned in the region of the trailing edge of the sheet, wherein a respective predetermined distance to the edge is maintained. A further development may be characterized by the downholders being symmetrical or mirror-symmetrical relative to each other. A further development may be characterized by the downholders being identical. A further development may be characterized by the parts of the downholders being made of metal sheet.

In accordance with yet another feature of the invention, the device may be provided with an arrangement of elements whose function is to press the sheets from above onto the transport table. In a preferred embodiment, the elements are formed as balls, particularly as balls of a ball rail. A further development may be characterized by a lifter being present which is positionable onto the format of the sheets in the transport direction and thereby lifting and, according to its function, passively placing at least one element. A further development may be characterized by the lifter being pivotably arranged on the linear guide or being pivotably arranged on another linear guide. A further development may be characterized by the lifter being couplable to the downholder such that both together are positionable onto the format of the sheets in the transport direction. A further development may be characterized by the coupling being performed magnetically. A further development may be characterized by a first magnet being present for the coupling. A further development may be characterized by uncoupling being performed at a stop. A further development may be characterized by a second magnet being present for the uncoupling. A further development may be characterized by coupling and uncoupling being performed at a stop. A further development may be characterized by the lifter being made of metal sheet.

In accordance with a concomitant feature of the invention, there may be provided a positioning element arranged on the downholder. A further development may be characterized by the positioning element being arranged laterally on the downholder. A further development may be characterized by the positioning element extending in the transport direction. A further development may be characterized by the positioning element having a length (e.g., labeled with L2) and the downholder being positioned at a distance of the length to a sheet edge using the positioning element.

The features and combinations of features disclosed above and in the following text represent—in any feasible combination—other advantageous, further developments of the invention.

Other features which are considered as characteristic for the invention are set forth in the appended claims.

Although the invention is illustrated and described herein as embodied in device for transporting sheets in a folder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1 to 3 each shows a perspective view of a preferred exemplary embodiment of a downholder of a device according to the invention.

FIG. 4 shows a perspective view of an alternative exemplary embodiment of a downholder of a device according to the invention.

FIGS. 5A and 5B show a perspective view and a top view, respectively, of a preferred exemplary embodiment of a device according to the invention.

FIGS. 6A and 6B show a perspective view and a top view, respectively, of a preferred exemplary embodiment of a device according to the invention.

FIGS. 7A and 7B show a perspective view and a top view, respectively, of a preferred exemplary embodiment of a device according to the invention.

FIGS. 8A and 8B show a perspective view and a top view, respectively, of a preferred exemplary embodiment of a device according to the invention.

FIGS. 9A and 9B each shows a section of a perspective view of a preferred exemplary embodiment of a device according to the invention.

FIG. 10 shows a top view of a preferred exemplary embodiment of a folding machine comprising a device according to the invention.

Corresponding features are provided with the same reference numerals throughout the figures. Repeating reference numerals have been partially omitted in the figures for reasons of clarity.

### DETAILED DESCRIPTION OF THE INVENTION

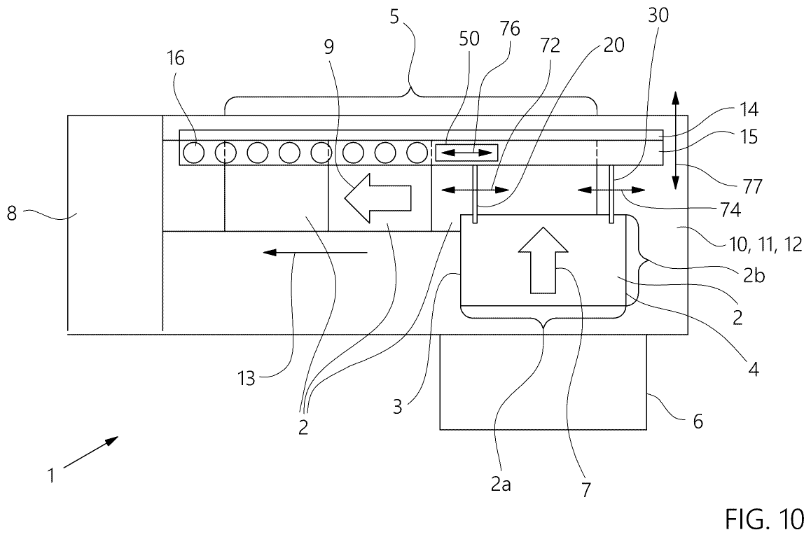

Referring now to the figures of the drawing in detail and first, for reference, to FIG. 10 thereof, there is shown a folding machine 1 using the invention, e.g., a buckle fold machine, for folding sheets 2, e.g., of paper. The sheets are preferably conveyed in a so-called shingle 5 or shingle stream. The folding machine 1, or folder, has a first folding station 6 and a second folding station 8 downstream in the production flow. A device 10 comprising a transport table 11, preferably having tilted transport rollers 12, is arranged between the folding stations. The sheets exit the first folding station 6 in an output direction 7 and are fed with a leading sheet edge 3 and a trailing sheet edge 4 to the second folding station 8 in a feeding direction 9. The transport direction 13 of the sheets 2 is parallel to the feeding direction 9 and parallel to a stop bar 14 and a ball rail 15 with balls 16 for the sheets 2, i.e., the sheets 2 experience a change of direction in the region of the transport table 11. As such, the sheets 2 exit the first folding station 6 in the direction 7, pass onto the transport table 11 and below the ball rail 15, and then abut the stop bar 14; eventually, at the stop bar 14, the sheets 2 are (further) conveyed along the transport direction 11 or the direction 9. During this process, in order to prevent a disruption by the sheets 2 having a given sheet format 2a, 2b (or only portions of the sheets 2) being lifted from the transport table 10, at least one downholder 20 is provided or present, preferably two downholders 20 and 30, wherein it/they is/are positionable, particularly slidable and fixable, in the direction 13 depending on the format (see movements 72 and 74).

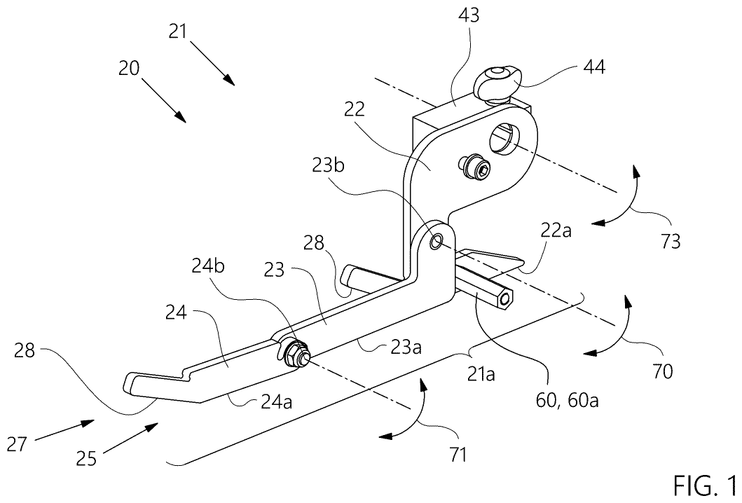

According to the invention, each of the downholders 20 and 30 comprises a multi-part finger 21 and 31 (see, e.g., FIGS. 1-4), wherein the length of the respective finger is adjustable to the format of the sheets. In addition, a lifter 50 for the balls 16 is provided or present, which is also positionable, particularly slidable, in the direction 13 depending on the format (see movement 76). The stop bar 14 and the ball rail 15, particularly together, are also positionable, particularly slidable and fixable, depending on the format (see, double arrow 77 indicating positioning movement).

Referring now in more detail to FIG. 1, the downholder 20 according to the invention comprises a multi-part finger 21 having a length 21a (when fully unfolded, as illustrated). The downholder 20 specifically comprises a first part 22 having a bottom 22a, a second part 23 having a bottom 23a, and a third part 24 having a bottom 24a. The second part 23 is pivotably arranged around a pivot axis 23b on the first part 22 (see pivoting movement 70). The third part 24 is pivotably arranged around a pivot axis 24b on the second part 23 (see pivoting movement 71). The respective bottoms together form a guide surface 25 for a sheet to be held down during transport.

The downholder 20 comprises a hopper 27 formed (when fully unfolded as illustrated) by an inlet region 28 angled or tilted upwards relative to the horizontal of the third part 24.

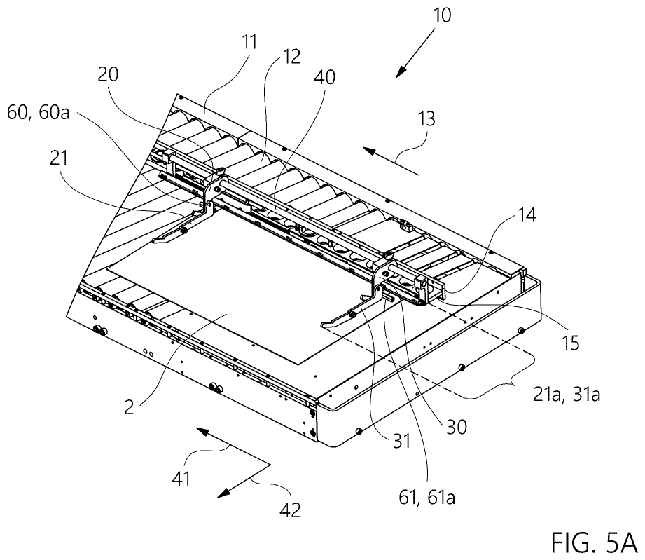

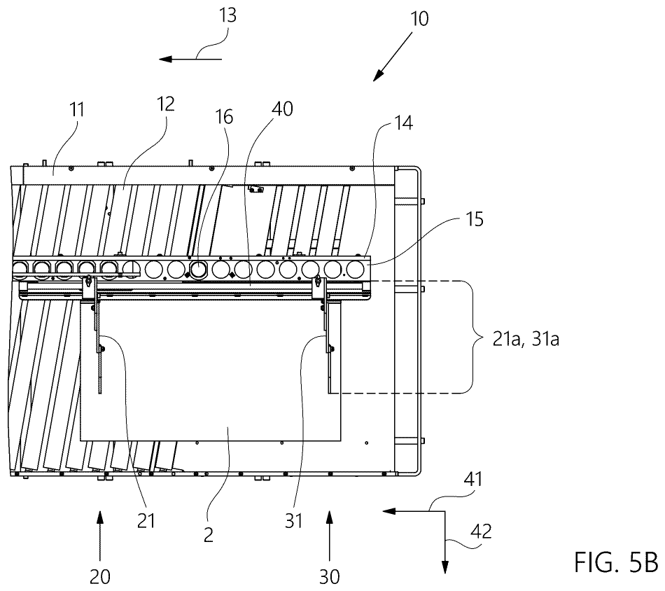

Furthermore, the downholder 20 comprises a slider 43 formed as a block with a hole and having a clamping element 44. Using the slider 43, the downholder 20 is positionable along a linear guide 40 (cf. FIGS. 5A to 8B), e.g., a rail, in the longitudinal direction 41 and fixable at a selected position, corresponding to a sheet format. In addition, the slider 43, and therefore also the downholder 20 as a whole, is pivotable about a pivot axis 73 and, in such a manner, may be pivoted or inactivated from an active position to an inactive position.

A positioning element 60 having a length 60a is also seen in FIG. 1. The downholder 20 may be positioned and fixed at a distance corresponding to the length 60a to a sheet edge using the positioning element 60 (as a measure).

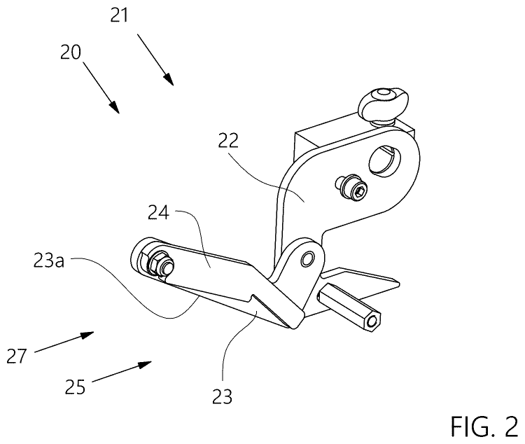

FIG. 2 shows the downholder 20 illustrated in FIG. 1, wherein it is now partially folded according to another sheet format: the third part 24 is folded and the second part 23 is tilted upwards. Thus, the length 21a of the finger 21 is reduced. In this position, the hopper 27 is formed by the bottom 23a of the second part 23.

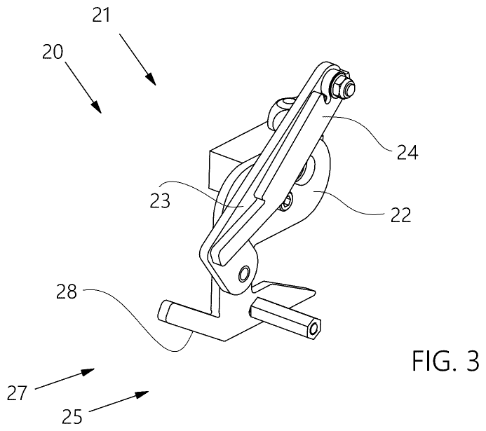

FIG. 3 shows the downholder 20 illustrated in FIG. 1 and FIG. 2, wherein it is now fully folded for processing yet another sheet format: the third part 24 and the second part 23 are folded. Thus, the length 21a of the finger 21 is further reduced. In this further position, the hopper 27 is formed by an inlet region 28 on the first part 22.

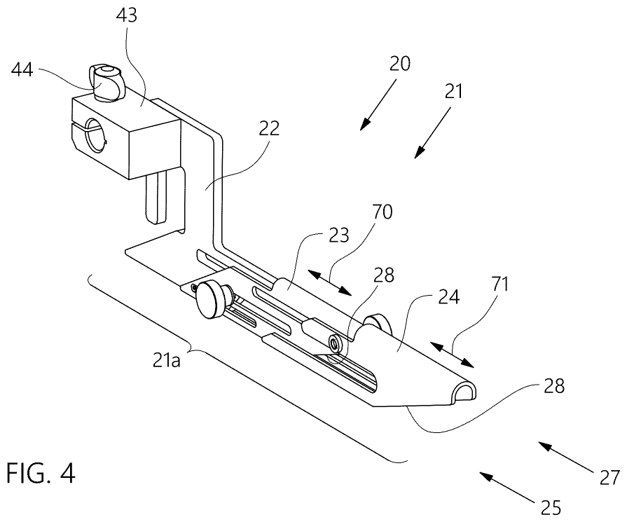

FIG. 4 shows an alternative embodiment of the downholder 20, embodied with a telescopic configuration, as opposed to the foldable design of FIGS. 1-3. Again, a multi-part finger 21 is provided, the length 21a of which may be changed by sliding the parts 23 and 24. Each of the parts 23 and 24 has a sloped inlet region 28.

FIGS. 5A and 5B show the same device 10 according to the invention. It comprises a transport table 11 having driven transport rollers 12 conveying the sheets 2 of a given format and/or type of fold in a transport direction 13. Furthermore, the device 10 comprises a stop bar 14 and a ball rail 15 with (downholding) balls 16 for the sheets 2. The device 10 has a longitudinal direction 41 and a transverse direction 42.

The device 10 shown comprises two downholders 20 and 30 according to the invention, each comprising a multi-part finger 21 and 31, respectively (compare FIGS. 1 to 3), wherein the respective lengths 21a and 31a of the fingers are changeable, preferably by partially or fully folding.

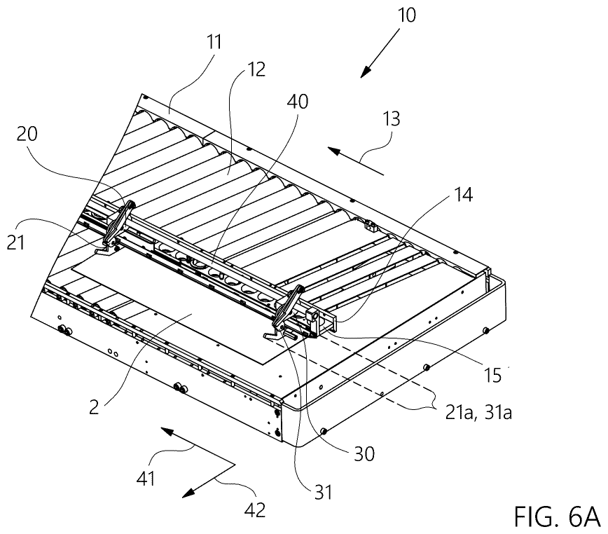

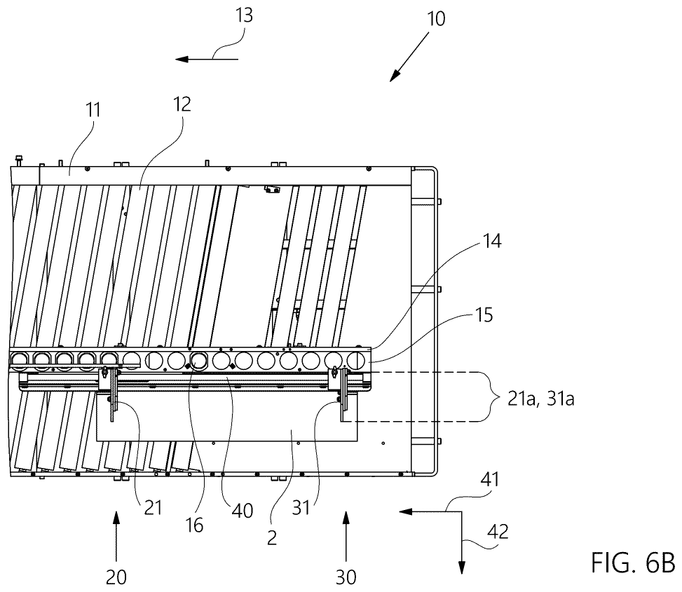

FIGS. 6A and 6B show the same device 10, but which transports a sheet 2 having a different format and/or type of fold. It can be seen that the two downholders 20 and 30, compared to FIGS. 5A and 5B, are positioned at another location (vertical format) and are also folded (horizontal format). Thus, the downholders 20 and 30 are adjusted according to the changed format and/or type of fold of the sheet 2 and therefore have a changed length 21a and 31a, respectively.

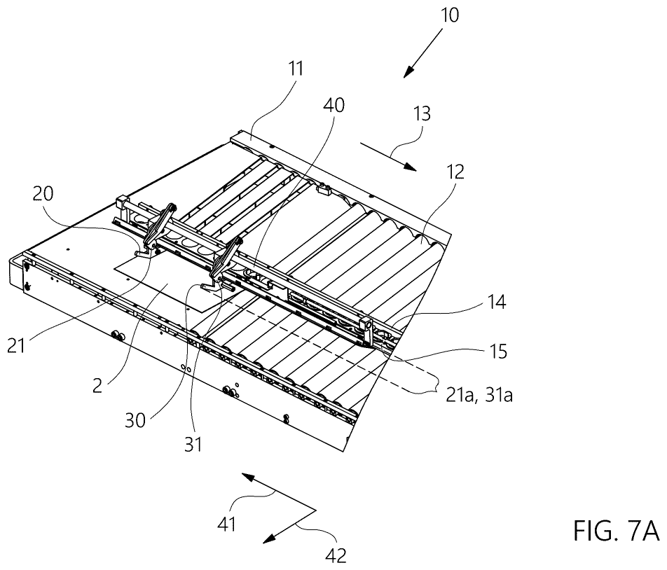

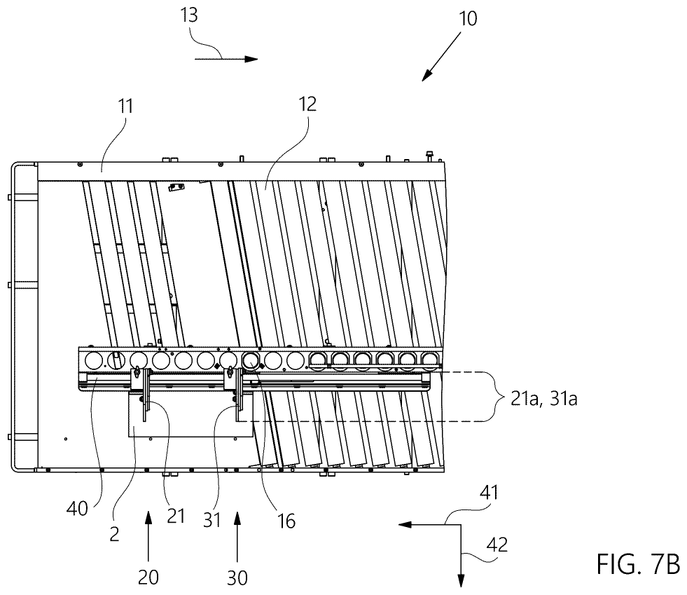

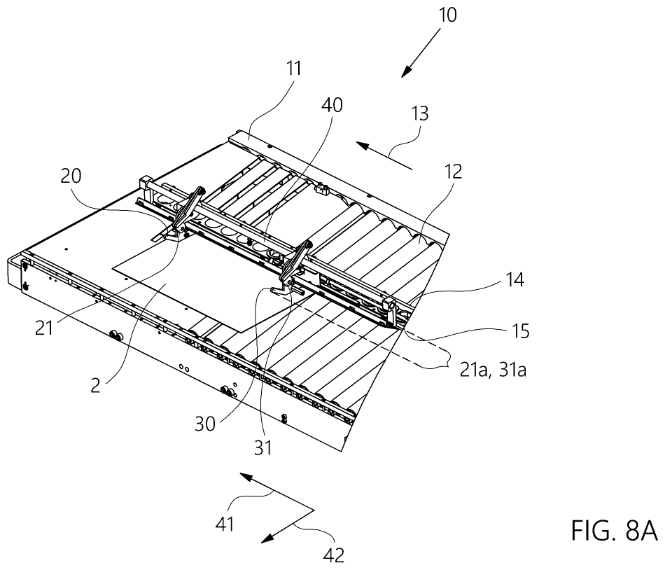

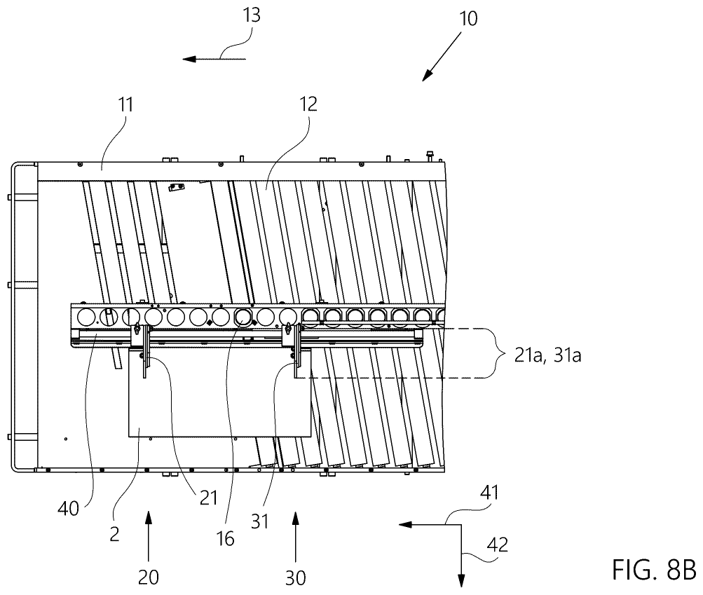

FIGS. 5A to 6B show a device 10 according to the invention following a first folding station, for example. FIGS. 7A and 7B, however, show a device 10 according to the invention following a downstream, second folding station, for example, causing the sheets to be transported in the opposite direction. The device 10 shown in FIGS. 7A and 7B is adjusted to another sheet format and/or type of fold: for example, it can be seen that the two downholders 20 and 30 are positioned closer relative to each other. FIGS. 8A and 8B also show a device 10 according to the invention following a second folding station. When comparing FIGS. 5A to 8B, it can be seen that the two downholders 20 and 30 may be adjusted to the vertical format and horizontal format of the sheets 2 to be transported, depending on the sheet format or the type of fold.

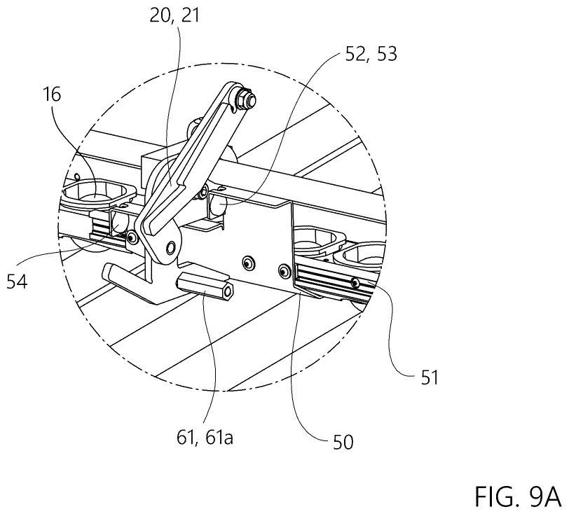

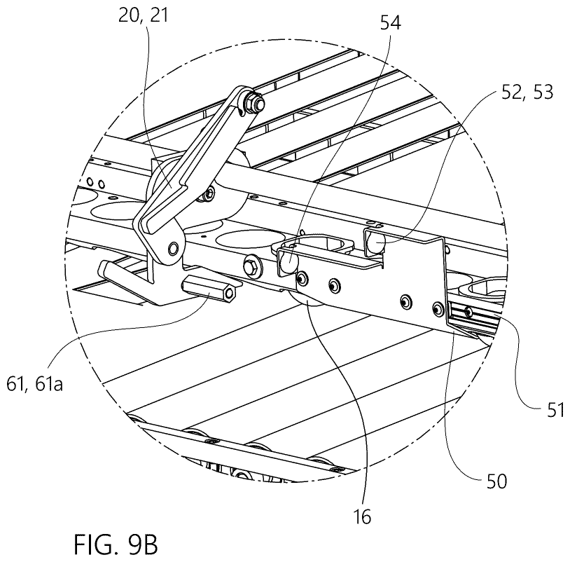

In FIGS. 9A and 9B, a lifter 50 for lifting balls 16 (not needed based on the format) is illustrated. Preferably, the lifter 50 is arranged on another linear guide 51 and therefore is adjustable in the longitudinal direction 41. The lifter 50 is couplable to the downholder 20 by means of a coupling 52, preferably via the first magnet 53 illustrated. When coupled, the lifter 50, together with the downholder 20, is moved or adjusted to the format to be transported and/or the type of fold. In this case, some of the balls 16 not needed based on the format and/or type of fold are lifted such that they do not rest upon the sheet 2 anymore. In specific formats, however, the downholder 20 and the lifter 50 need to be uncoupled. To do this, the lifter 50 (e.g., during a forward movement of the downholder 20) may be uncoupled at a stop and preferably maintained positioned at the stop using a second magnet 54 until the lifter 50 is coupled again to the downholder 20 (e.g., during a rearward movement of the downholder 20). Coupling and uncoupling are performed automatically during movement of the downholder 20 in the longitudinal direction 41 according to the position of the stop.

The following is a summary list of reference numerals, and the corresponding structure used in the above description of the invention:
1 folding machine
2 sheet
2a sheet format (length or vertical format)
2b sheet format (width or horizontal format)
3 (leading) sheet edge
4 (trailing) sheet edge
5 shingle
6 first folding station
7 output direction
8 second folding station
9 feeding direction
10 device
11 transport table, specifically roller table
12 transport rollers
13 transport direction
14 stop bar for sheets
15 arrangement of elements, specifically ball rail
16 elements, specifically balls
20 downholder
21 multi-part finger
21a length of the finger
22 first part
22a bottom of the first part
23 second part
23a bottom of the second part
23b pivot axis of the second part
24 third part
24a bottom of the third part
24b pivot axis of the third part
25 guide surface
27 hopper
28 inlet region(s)
30 other downholder
31 other multi-part finger
31a length of the other finger
40 linear guide, specifically a rail
41 longitudinal direction
42 transverse direction
43 slider
44 clamping element
50 lifter
51 other linear guide
52 coupling, specifically magnetic
53 first magnet
54 second magnet
60 positioning element
60a length L of the positioning element
61 other positioning element
61a length of the other positioning element
70 (pivoting or linear) movement of the second part
71 (pivoting or linear) movement of the third part
72 (linear) movement of the downholder
73 (pivoting) movement of the downholder
74 (linear) movement of the other downholder
76 (linear) movement of the lifter
77 (linear) movement of the stop bar and ball rail

1. A device for transporting sheets in a folding machine, comprising a transport table (11) with a transport direction (13) for the sheets (2) and at least one downholder (20) for the sheets positionable onto the format (2a) of the sheets (2) in the transport direction (13), characterized in
that the downholder (20) comprises a multi-part finger (21), wherein there are at least a first part (22) and a second part (23), and wherein the second part (23) is movable relative to the first part (22) such that the length (21a) of the finger (21) is adjustable to the format (2b) of the sheets (2).

2. The device according to claim 1,
characterized in
that the second part (23) is arranged on the first part (22).

3. The device according to claim 2,
characterized in
that the second part (23) is pivotable or slidable relative to the first part (22).

4. The device according to any one of the preceding claims,
characterized in
that the multi-part finger (21) comprises a third part (24) which is movable relative to the second part (23) such that the length (21a) of the finger (21) is adjustable to the format (2b) of the sheets (2).

5. The device according to claim 4,
characterized in
that the third part (24) is arranged on the second part (23).

6. The device according to claim 5,
characterized in
that the third part (24) is pivotable or slidable relative to the second part (23).

7. The device according to any one of the preceding claims,
characterized in
that the device (10) comprises a linear guide (40), the longitudinal direction (41) of which is parallel to the transport direction (13), and that there is a slider (43) slidably arranged on the linear guide (40), and which the downholder (20) is arranged on.

8. The device according to claim 7,
characterized in
that the downholder (20) is pivotably arranged on the linear guide (40).

9. The device according to any one of the preceding claims, characterized in that the downholder (20) has a guide surface (25) for the sheets (2).

10. The device according to claim 9,
characterized in
that the guide surface (25) comprises an inlet region (28).

11. The device according to any one of the preceding claims,
characterized in
that the device (1) has the downholder (20) and at least one other downholder (30), each comprising a multi-part finger (21, 31), the respective lengths (21a, 31a) of which are adjustable to the format (2b) of the sheets (2).

12. The device according to any one of the preceding claims,
characterized in
that the device (1) comprises an arrangement of elements (15), the functionality of which is to press the sheets (2) from above onto the transport table (11).

13. The device according to claim 12,
characterized in
that the elements (6) are formed as balls (16).

14. The device according to any one of the preceding claims,
characterized in
that there is a lifter (50) positionable onto the format (2a) of the sheets (2) in the transport direction (13) and thereby lifting and, according to its function, passively placing at least one element (16).

15. The device according to claim 14,
characterized in
that the lifter (50) is couplable to the downholder (20) such that both together are positionable onto the format (2a) of the sheets (2) in the transport direction (13).

16. The device according to claim 15,
characterized in
that coupling is performed magnetically.

17. The device according to claim 16,
characterized in
that uncoupling is performed at a stop (55).

18. The device according to any one of the preceding claims,
characterized in
that a positioning element (60) is arranged on the downholder (20).

19. The device according to claim 18,
characterized in
that the positioning element (60) has a length (60a), and that the downholder (20) is positioned at a distance of the length (60a) to a sheet edge (3, 4) using the positioning element (60).

20. A folding machine, comprising a first folding station (6) and a second folding station (8) arranged downstream in the production flow,
characterized in
that a device (10) according to any one of the preceding claims is arranged in the production flow between the first folding station (6) and the second folding station (8).
